(19) United States
(12) Patent Application Publication
(10) Pub. No.: US 2021/0249147 A1
(43) Pub. Date: Aug. 12, 2021

(54) Cold fusion and other methods for producing energy etc.

(71) Applicant: Menni Menashe Zinger, Ashkelon (IL)

(72) Inventor: Menni Menashe Zinger, Ashkelon (IL)

(21) Appl. No.: 16/785,573

(22) Filed: Feb. 8, 2020

(51) Int. Cl. G21B 3/00

(52) U.S. Cl. CPC G21B 3/00

(57) ABSTRACT

This invention show how to produce energy at special ways without pollution and at very efficient way.

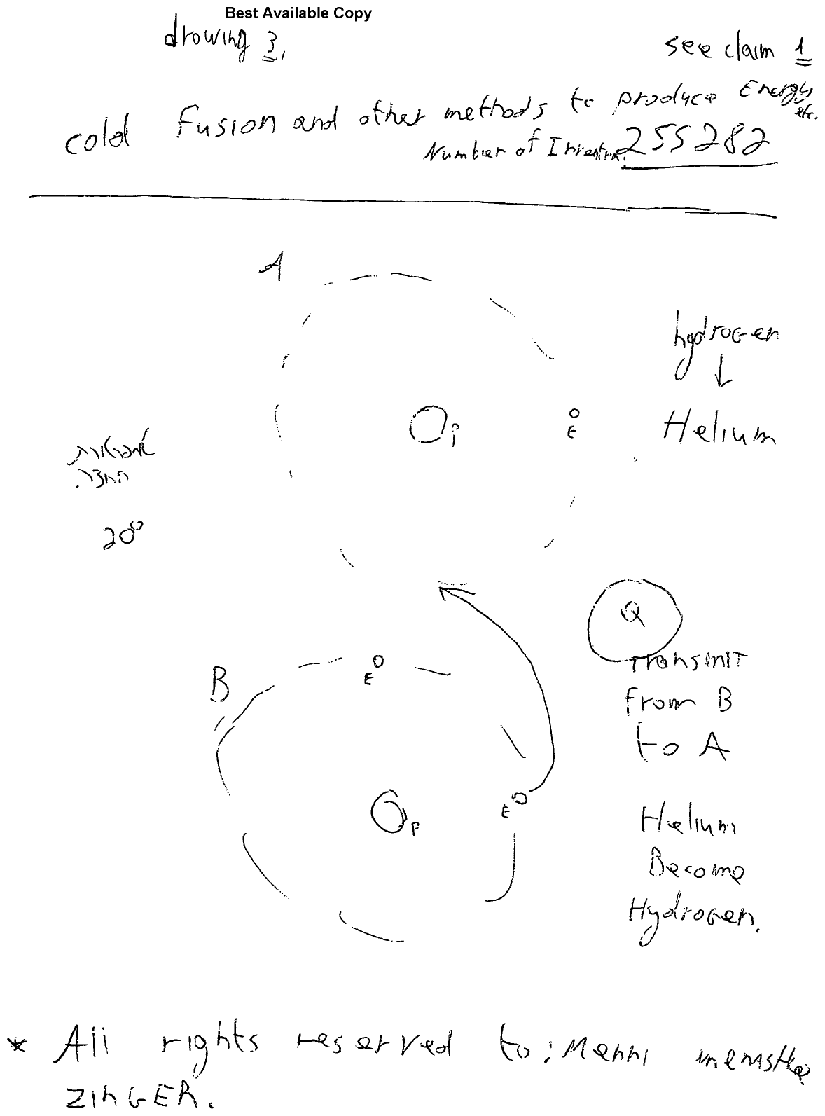

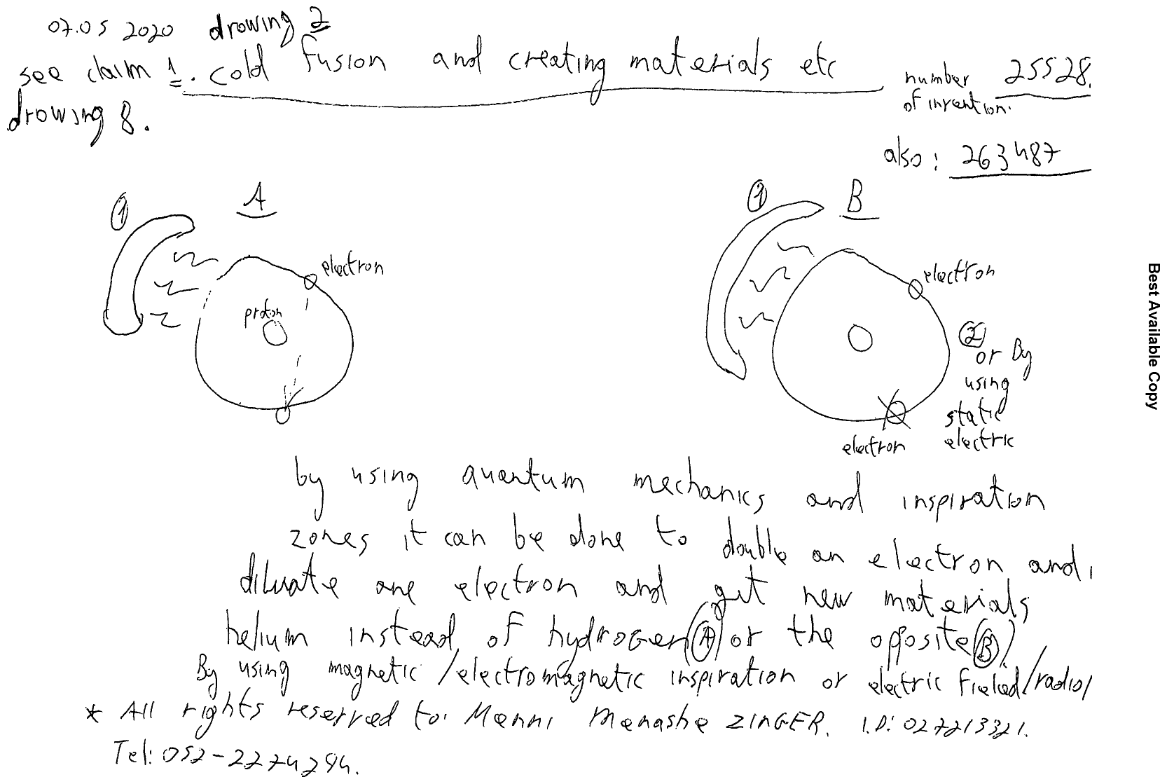

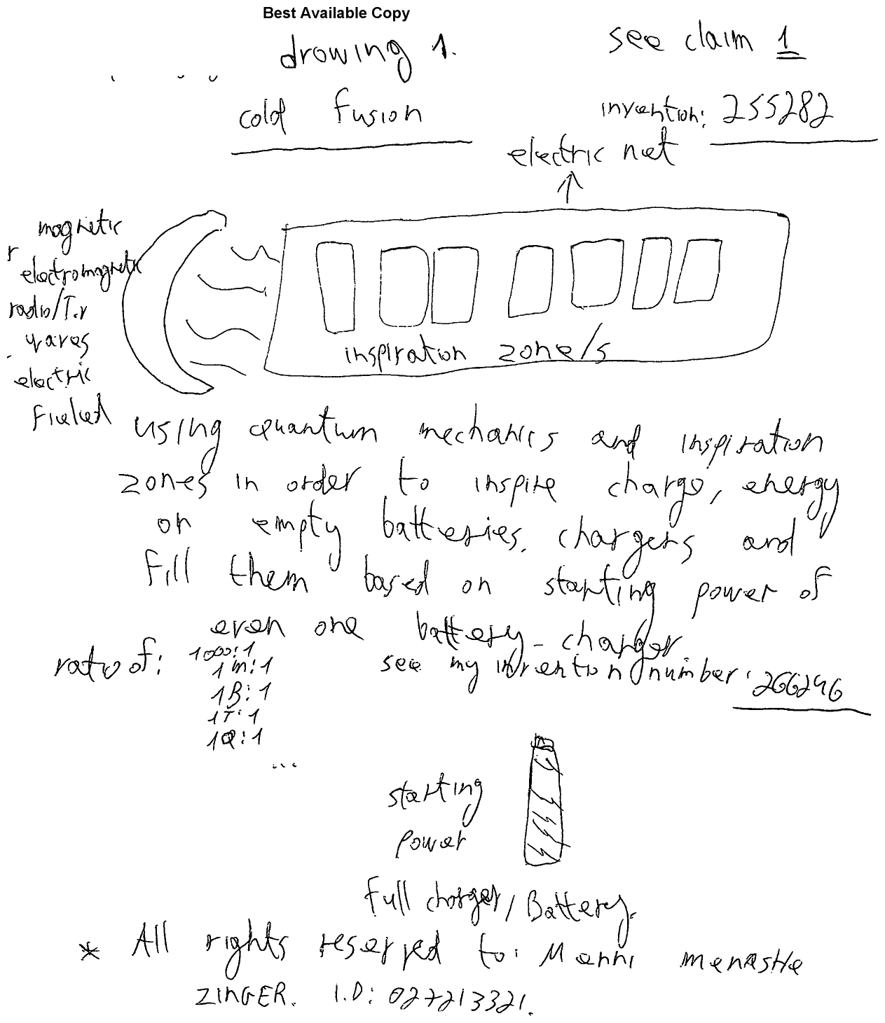

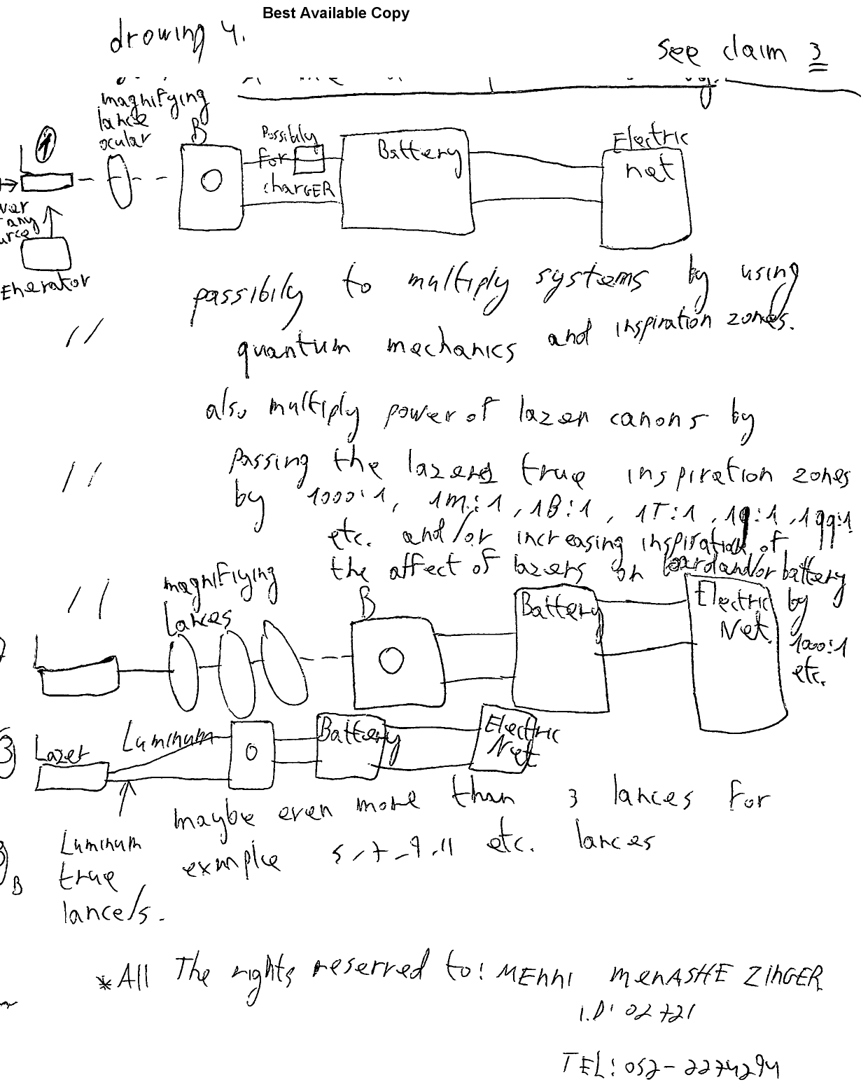

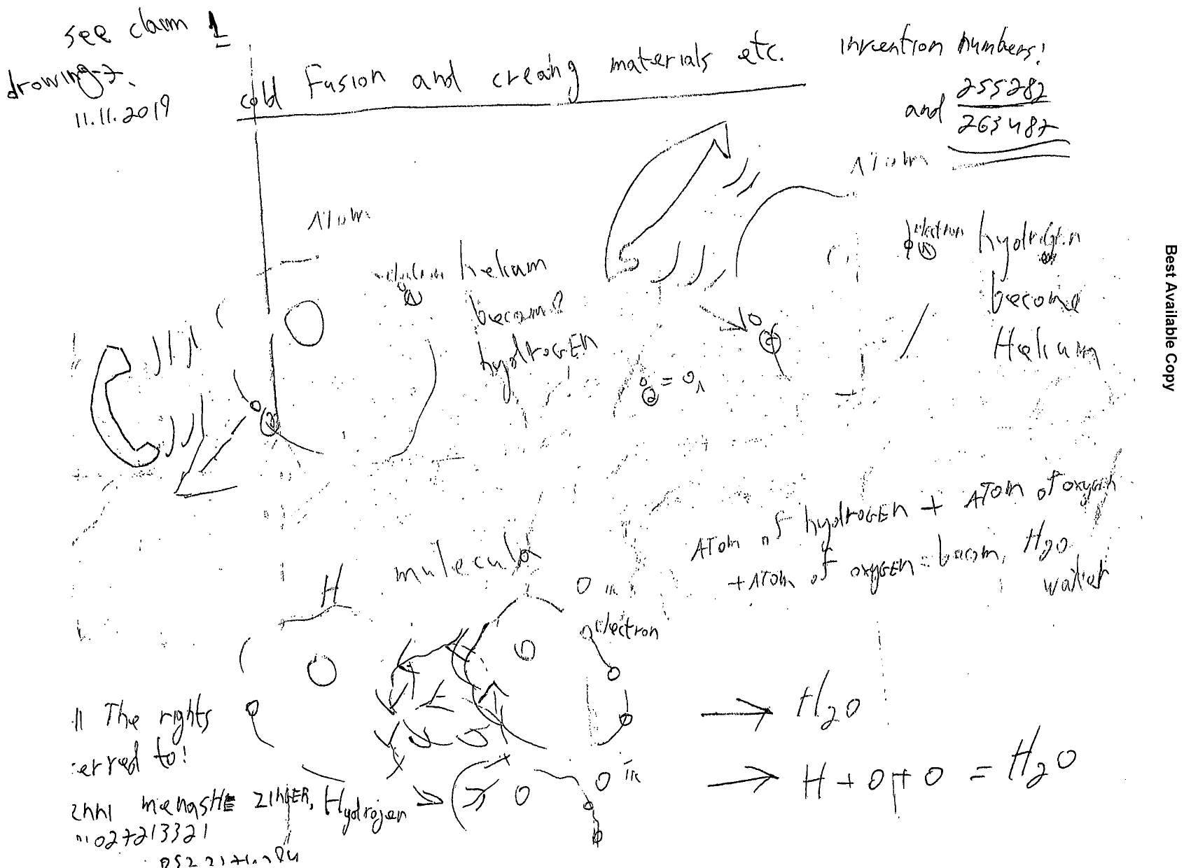

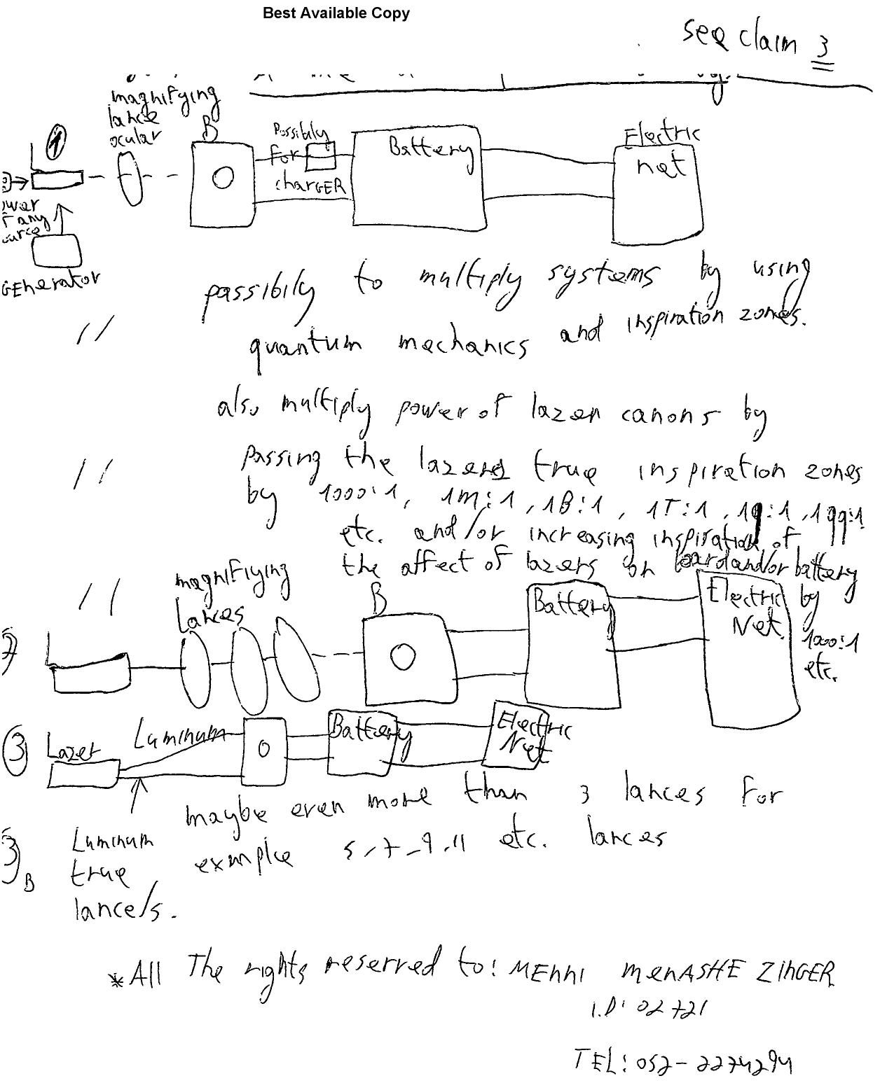

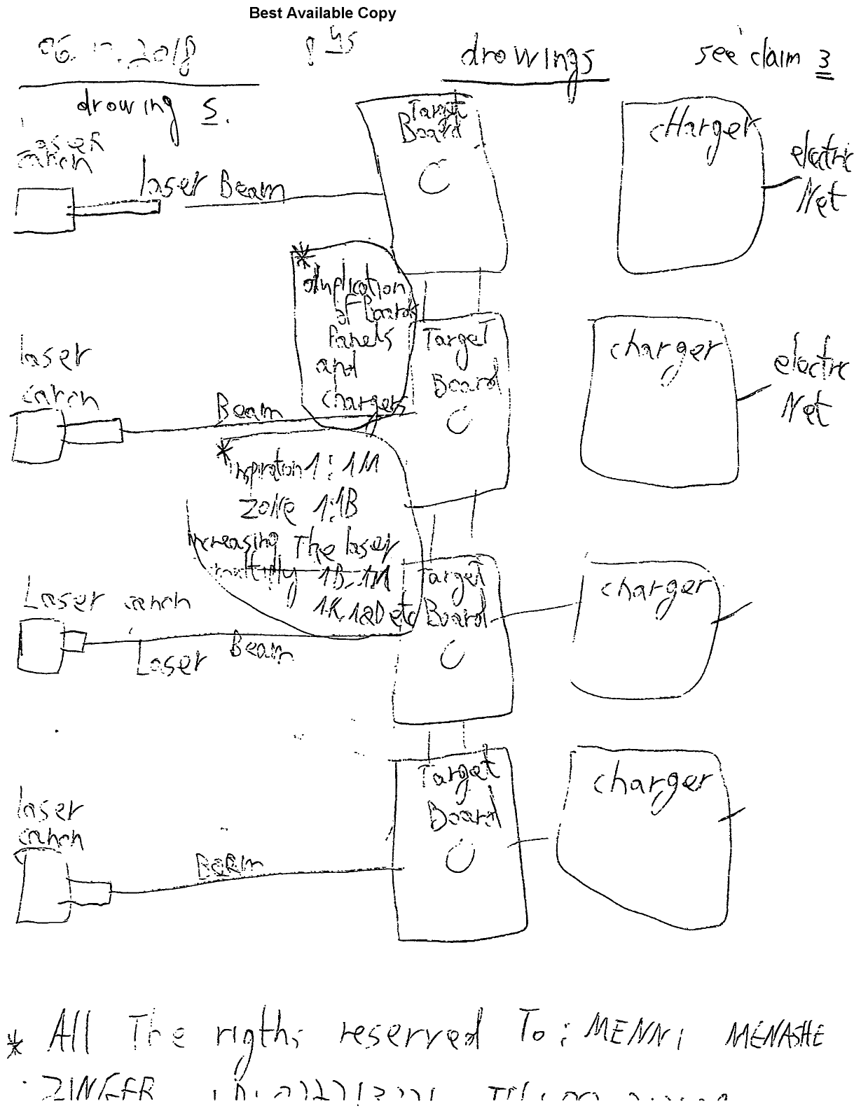

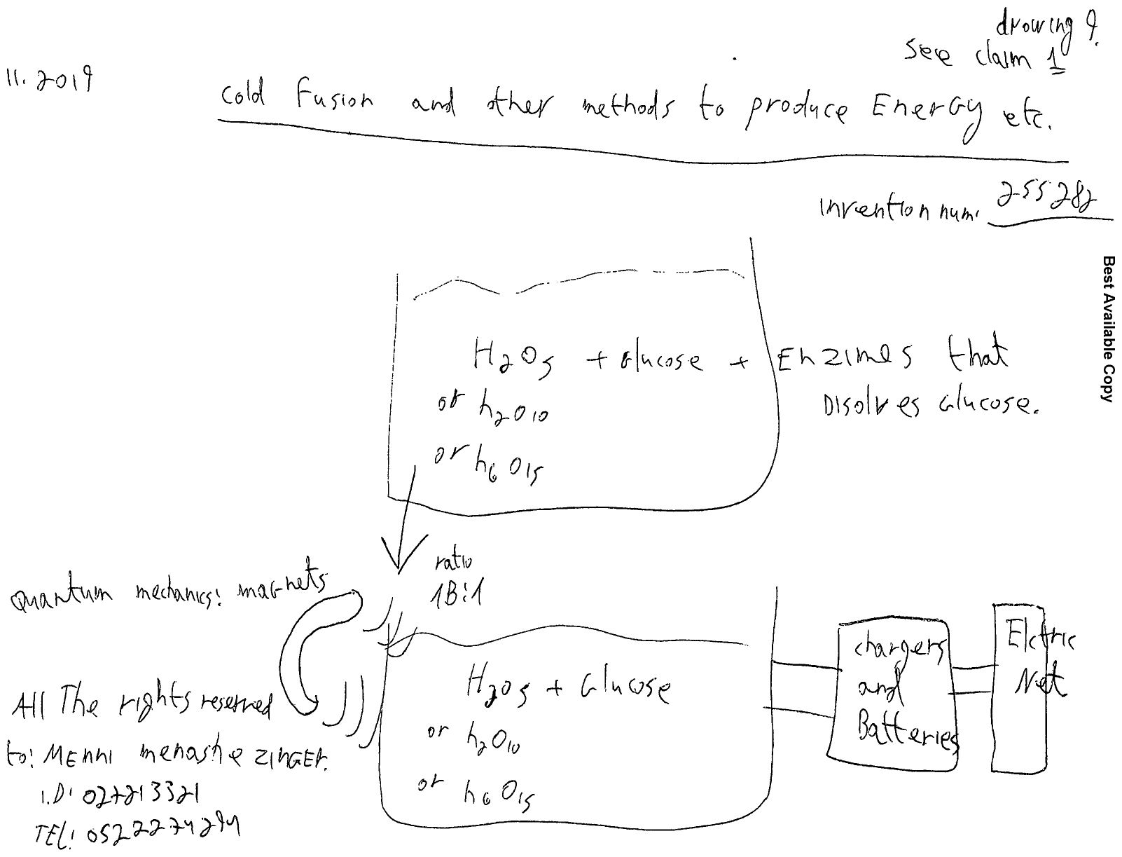

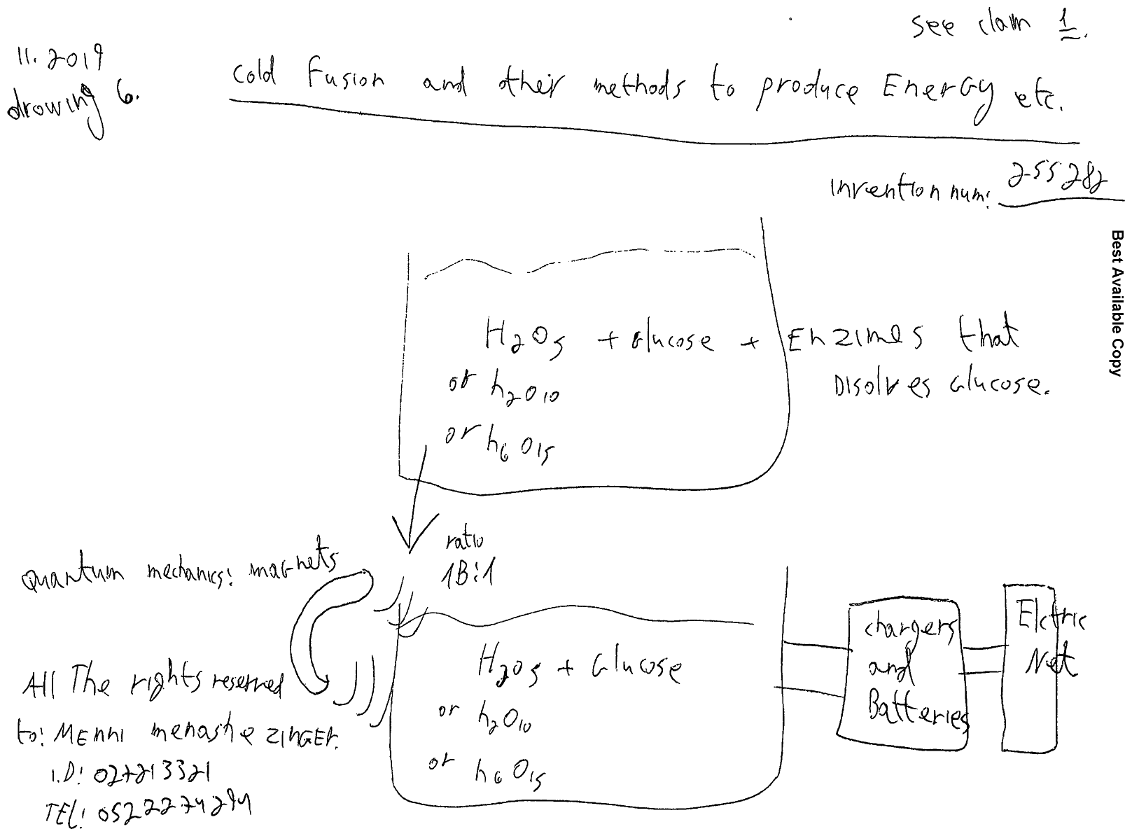

This invention and those methods describe ways to produce great energy at special ways without polluting the area and environment and without creating great heat at least most of them.

The invention can be used also for all kinds of vehicles, at least part of the methods feet for that.

As we know there is a big problem with pollution at the world and also shortage at energy supply and some day the oil will be finished at earth. it also expensive to use vehicles with internal burning every day every month. The public of drivers and company owners and managers will be happy to reduce their expenses and also to not pollute the environment subject that has high popularity at the public at the last decades. the subject of energy shortage causing wars at the world and other good solution will help a lot to the peace at the world. I invented over 90 methods to produce energy detailed at the claims at that invention, using them can solve the energy crisis completely.

Some of the ways like the basic formulas feet more for using at power stations and other for vehicles, some for reactors. some of the invention can use materials at the environment.

This invention can solve the energy problem forever.

There are different kinds of methods that feet to different countries with different nature resources and different style. And or different considerations.

1. using h2o and or h2o5 and at addition glucose, multy sugars, fats, trans fats, lipids, coffee, oil sumsum, proctoze, zinc, corn, tea leaves, oil lemon, pumpkin, fistul emphitamins, natural and/or sinthetic, palm oil soybean, ful, broad bean, pumpkin extract, lemon balm stimulating substance, pinuts, kakaoo, soya, tea, rush, yeast, carbon, glycogen iron and enzymes that feet for example glycogen sintaz, n epinperin lipaz and others it can be natural and/or synthetic. the dissolve of the mix should release energy hidden in the mix. The materials can be kept at separate cubes with round corners at the bottom in order to easier the cleaning and at the center h2o or h2o5 etc. at the top of cabs, cubes a cover with pneumatic/hydraulic mechanizem in order to block air to get in. it is possible to electresize the formula in order to release ions and electrons and maybe gain energy by that. molecule like h2o5 can save place in front of h2o and that important at vihcles for example but not only and using all materials at that claim and quantum mechanics and inspiration zones by my invention number: 266246.il.2019. “time machines and traveling at time and diamentions etc.” and inspiring one or every combination of the materials inside capsules on chargers and batteries at ratio of 1000:1, 1 million:1, 1 billion:1, 1 quardilion:1, 1 quardilion*quardilion:1 etc. the batteries and chargers should be close enough in order to let quantum mechanics and inspiration zones on them effective enough, the possible distance need to be tested. it is possible to take battery and inspire it at ratio of 1 quardilion:1 on line of batteries. possibility that adding sulfates into h2o5 and with suppliments will shut it down but there is also a possibility that it would add power to the mix. Using heating of the pool by few degrees celcius or more let say not more that 30 degrees celcius that room temperature and by that make the formula be more efficient including with different suppliments, all of the that I wrote at this invention. Using freezing of pool in order to stop operation in case of such decision and keep it at this situation.

2. using quantum mechanics and inspiration zones in order to multiply photosynthesize energy and inspire it on batteries and fill the batteries, chargers. the plants use chlorophile for that also mitochondria at human body can be duplicated, multiplied and inspired on batteries, chargers. also emetate fusion at red sun and adding electron with using quantum mechanics and inspiration zones . . . using quantum mechanics and inspiration zones in order to increase power of lasers heating boards infront of the laser guns, canons and also multipliying the batteries by inspiration zones by using magnetic/electromagnetic/electric filed/radio/t.v. waves in order to create the inspiration zones and for multiplying. the energy at the heatboard will pass to chargers and from there to batteries and to the electric net of city, state etc. (see also drowing number 1.)
using quantum mechanics and inspiration zones in order to diluate material into zero or less, minus and get anti metter, anti material and that can create great energy, maybe great blust so the realease should be at close to zero from minus side and triying to controle the process and avoid blust that can be used as a weapone. using static electric in order also to dilute materials and people also . . . using magnetic/electromagnetic frequency/ies in order to dissolve atom, molecule, release ions etc. it can be used at vihcles, plains, spacesheeps, sheeps space stations etc. also and controlled with button and also for reactors at power stations, factories etc. cities etc. the materials in use can be different for example h2o, carbon that would not be burned, proctoze, zinc, cohel, alcohol etc. also opposite magnets by changing direction.
using magnetic power on an atom and breaking its structure and removing an ion, electron or proton or neutron by using different amount of power and aiming to different deepness of the atom if it is possible to be very accurate it is possible to pull other partical/s to the atom by using magnetic power or electromagnetic power waves, radiation and/or radio/t.v waves and/or dissolve it, those forces can be operated by using quantum mechanics and inspiration zones and also it is possible to duplicate an partical of any kind like proton, electron, ions, neutrons and/or atom, molecule etc. it is cold fusion as it sounds. it is possible that making for example hydrogen into helium will create much energy. It is possible to create any material from any other material including gold, diamonds etc. also it is possible to duplicate any materials by using quantum mechanics and inspiration zones. it is possible to connect atoms and create molecules by using quantum mechanics and inspiration zones with using magnetic powers for example. The magnets should be pointed accuratle and or painting the ions/electrons at magnetic color at mathing between the magnet frequanct/power to the partical need to be taken out of atom. using also electric files/current accurately. into h2o or other material. And/or neutreons and/or neutrino canon with no electric charge pointed to a point at their orbit like an ambush on way and the neutral charge would not affect the ions can be tested. electrons stream, electric stream would act differently.

3. using h2o and freon, as liquid aerosol, gas, in order to remove oxygen from water and left with hydrogen and from it to release ion by ion by using ion tractor and using the energy at the ions in order to produce energy. it can be used at power stations and/or vihcles of any kind and scale, for example cars, trucks, bussess, trains, plains, chappers, satelites, space sheeps, space stations etc.. also using gentle electric current in order to disapart atom, also its proton of any material not only radioactive and gain energy by that use, method. also using codensation, condensing that is being create by difernces of temperature at water at law temperature like 15-20 degrees celcius for example on windows, glussess, metal and using freon on the same place that will dissolve the oxygen and only hydrogen will be left that can be used to produce energy by trading ions by using ion tractor passing it true charger and battery using katode in order to creat fall of ions into charger and batteries is possible and or burning the hydrogen at quiet law temperature. also Using led and/or iron, synthetic plasma from in order to tract oxygen from hydrogen and that use hydrogen for energy by dissolving ions by using ion tractor and passing them to charger and batteries of vihcles and or power stations of any kind or size, huge ones, medium or for building houses appartments, offices, factories, streets etc. also using magnetic influence at different frequancies and power/volume, that will affect only oxygen or only hydrogen in order to separate between them and still enjoy the benefit of carrying them as h2o for example at safe way. magnetizing the oxygen and or freon at certian frequancies can make it easier to freon to dissolve oxygen more efficiently than regular way.
Using protein as suppliment to the basic formula for increasing efficenty. theory at phisics:materials has different layers of sub particles that got heated or cooling or getting tayerd at different times as deep the materials goes to smaller sub particles. so 1 hour of rest to a material is not the same as 3 hours or 6 hours. the reason again is the existence and different caricature of sub particles from different size and kind.
